(19) United States
(12) Patent Application Publication
(10) Pub. No.: US 2010/0157590 A1
(43) Pub. Date: Jun. 24, 2010

(54) CONDENSING ELEMENT SYSTEMS AND METHODS THEREOF

(75) Inventors: James F. Munro, Walworth, NY (US); Penny J. Munro, Walworth, NY (US)

Correspondence Address: NIXON PEABODY LLP - PATENT GROUP, 1100 CLINTON SQUARE, ROCHESTER, NY, 14604, US

(73) Assignee: REFLEXITE CORPORATION, Avon, CT (US)

(21) Appl. No.: 12/342,798

(22) Filed: Dec. 23, 2008

(51) Int. Cl. F21V 13/04; F21V 7/00; G02B 19/00

(52) U.S. Cl. 362/235; 362/231; 359/726; 362/309

(57) ABSTRACT

A condensing element system and method thereof includes a first section for each of one or more condensing elements and a second section for each of the one or more condensing elements. The first section for each of one or more condensing elements provides substantially total internal reflection of light entering at a base of the first section. Each of the second sections is optically coupled to one of the first sections and has an output surface with one or more peaks and one or more troughs. The first and second sections for each of the condensing elements are each configured so a half-power angle of the light output from the second section is less than the half-power angle of the light entering the first section.

### FIELD OF THE INVENTION

This invention generally relates to condensing element systems and, more particularly, to low-height, compact, totally internally reflecting (TIRing), condensing element systems and methods thereof

### BACKGROUND

Typically, a light emitting diode (LED) emits light into a full hemisphere. For some applications, such as for display lighting or general room lighting, such an output can be desirable. However, for other applications, such as for backlighting or architectural lighting, a more focused output is required.

To provide a narrower output light distribution angle, the light output from the LED often is condensed. A variety of devices have been developed to condense light from an LED, such as devices that utilize a parabolic reflector. Unfortunately, these prior devices have a number of drawbacks including being expensive to produce, physically large, inefficient, and unable to condense all of the light into a narrow output emission profile.

An alternate prior art method of condensing light from a source is shown in FIG. 1. This prior-art optical element has an input surface 1 onto which light source 14 is located, an outer TIRing surface 2, and a lens-shaped output surface 3 through which all the light must exit. Exemplary light rays 5 and 6 directly propagate from the source 14 to and exit from the output surface 3 at locations 5A and 6A, respectively, in a direction that is substantially parallel to the optical axis A-A of the optical element. The prescription of the lens-shaped output surface 3 is designed for this purpose.

Unfortunately not all of the light that exits the source 14 is directly incident onto the output surface 3. For example, light ray 7 undergoes TIR at the outer TIRing surface 2 at location 7A, and then is incident on the output surface 3 at location 7B. Light ray 7 refracts and exits through outer surface 3 at location 7B, and is directed in a direction that is not substantially parallel to the optical axis A-A. Therefore, light ray 7 is not well condensed, and detracts from the overall performance of the optical element. In this way, most prior art optical elements suffer from poor light-condensing efficiency.

An alternate prior art light condensing element is shown in FIG. 2. This design has a first bowl portion bounded by surfaces 11 and 12, and a second conical-shaped portion bounded by surface 13. This design does not rely upon a focusing lens to achieve good light condensing, but instead relies upon a judiciously designed TIRing surface 12 that cooperatively interacts with conical TIRing and refracting surface 13 such that substantially all rays emitted by the source 14 are condensed.

For example, light ray 15 is emitted by the source 14 at an oblique angle and TIR's at surface 12 at location 15A. The light ray 15 continues to propagate upward into the conical section where it is incident on surface 13 at location 15B and, in this example, TIR's once again. Light ray 15 continues to propagate further up into the conical section where it once again is incident on surface 13, at location 15C, where it refracts through surface 13 in a direction substantially parallel to the optical axis B-B.

Another exemplary light ray emitted by the source 14 in FIG. 2, is light ray 17 which is emitted at a non-oblique angle by the source 14. Light ray 17 is not incident on the bowl-shaped surface 12, but instead is directly incident on conical surface 13 at location 17A. Light ray 17 TIRs at location 17A and continues to propagate up further into the conical section where it is again incident on surface 13 at location 17B. At location 17B, light ray 17 refracts through surface 13 in a direction substantially parallel to optical axis B-B. In this way both obliquely emitted light ray 15 and non-obliquely emitted light ray 17 are well-condensed.

However, a drawback of the condensing element illustrated and described with reference to FIG. 2 is that the height of the condensing element, which is the distance from the base surface 11 to the peak 16 along axis B-B, can be physically large, exceeding a centimeter in some applications. This results in an optical condensing element that is composed of an inordinate amount of material, has long manufacturing (injection molding) cycle times, and requires that a final product that the condensing element is used in must also have considerable height. For these reasons the TIRing condensing element of FIG. 2 is not ideal for low-cost and low-height applications.

### SUMMARY

A condensing element system in accordance with embodiments of the present invention includes a first section for each of one or more condensing elements and a second section for each of the one or more condensing elements. The first section for each of one or more condensing elements provides substantially total internal reflection of light entering at a base of the first section. Each of the second sections is optically coupled to one of the first sections and has an output surface with one or more peaks and one or more troughs. The first and second sections for each of the condensing elements are each configured so a half-power angle of the light output from the second section is less than the half-power angle of the light entering the first section.

A method for making a condensing element system in accordance with other embodiments of the present invention includes forming a first section for each of one or more condensing elements that provides substantially total internal reflection of light entering at a base of the first section. A second section for each of one or more condensing elements is formed that is optically coupled to one of the first sections and has an output surface with one or more peaks and one or more troughs. The first and second sections are configured so a half-power angle of the light output from the second section is less than the half-power angle of the light entering the first section.

Accordingly, the present invention provides a condensing element system that may be optically coupled to one or more LED sources to provide low-loss intensity concentration. Additionally, the present invention provides a condensing element system that is easy and inexpensive to manufacture and which has a compact low-height design. Further, another benefit of the present invention is that the condensing element system improves the efficiency of the light source. Even further, the present invention provides a condensing element system which requires less material to manufacture, has shorter manufacturing (injection molding) cycle times, and has lower overall height than prior condensing element systems.

### BRIEF DESCRIPTION OF THE DRAWINGS

FIG. 1 is a cross-sectional side view of a prior art condensing element that utilizes both TIR and refraction to condense light, but cannot condense both oblique and non-oblique light rays emitted by a source;

FIG. 2 is a cross-sectional side view of a prior art condensing element that utilizes both TIR and refraction to condense both oblique and non-obliquely emitted source light, but suffers from being physically large along its optical axis;

FIG. 3A is a cross-sectional side view of a condensing element with a single light source for a condensing element system in accordance with embodiments of the present invention;

FIG. 3B is a plan view of the condensing element with a single light source shown in FIG. 3A;

FIG. 4 is a diagram of an example of geometrical calculations for generating a TIRing section of a condensing element for a condensing element system in accordance with embodiments of the present invention;

FIG. 5 is a spreadsheet of examples of coordinates for the profiles of the TIRing section of condensing element for a condensing element system in accordance with embodiments of the present invention;

FIG. 6A is a cross-sectional side view of a condensing element with multiple light sources for a condensing element system in accordance with other embodiments of the present invention;

FIG. 6B is a plan view of the condensing element with multiple light sources shown in FIG. 6A;

FIG. 7A is a cross-sectional side view of another condensing element with a single light source for another condensing element system in accordance with other embodiments of the present invention;

FIG. 7B is a plan view of the condensing element with a single light source shown in FIG. 7A;

FIG. 8A is a cross-sectional side view of yet another condensing element with a single light source for another condensing element system in accordance with other embodiments of the present invention;

FIG. 8B is a plan view of the condensing element with a single light source shown in FIG. 8A;

FIG. 8C is a plan view of a cross-hatched condensing element with a single light source for another condensing element system in which the height of a second section of the condensing element has been even further reduced in accordance with other embodiments of the present invention;

FIG. 9 is an isometric view of an exemplary condensing element for a condensing element system in accordance with other embodiments of the present invention;

FIG. 10 is a cross-sectional side view of a condensing element system with a film forming the second sections with a continuous pattern of the one or more peaks and one or more troughs in accordance with other embodiments of the present invention;

FIG. 11 is a cross-sectional side view of a condensing element system with a film forming the second sections with a discontinuous pattern of the one or more peaks and one or more troughs in accordance with other embodiments of the present invention;

FIG. 12A is a plan view of a condensing element system with a monolithic array of overlapping condensing elements in accordance with other embodiments of the present invention;

FIG. 12B is a cross-sectional side view of the condensing element system shown in FIG. 12A;

FIG. 13 is a plan view of a condensing element system with a monolithic array of overlapping condensing elements along with electrical power conductors in accordance with other embodiments of the present invention;

FIG. 14 is a cross-sectional side view of a condensing element system with a monolithic array of overlapping condensing elements with integrally formed first and second sections in accordance with other embodiments of the present invention;

FIG. 15 is a cross-sectional side view of another condensing element with an encapsulated light source for another condensing element system in accordance with other embodiments of the present invention;

FIG. 16 is a ray trace output graph of a rectangular candela distribution of light without a condensing element in accordance with the present invention;

FIG. 17 is a ray trace output graph of a rectangular candela distribution of condensed output light in accordance with an exemplary embodiment of the present invention;

FIG. 18 is a cross-sectional view of a prior art LED die-based light source with two exemplary emitted light rays;

FIG. 19 is a partial, cross-sectional side view of a condensing element for a condensing element system with an exemplary emitted light ray from an LED die-based light source in accordance with other embodiments of the present invention; and

FIG. 20 is an exemplary table of emissions.

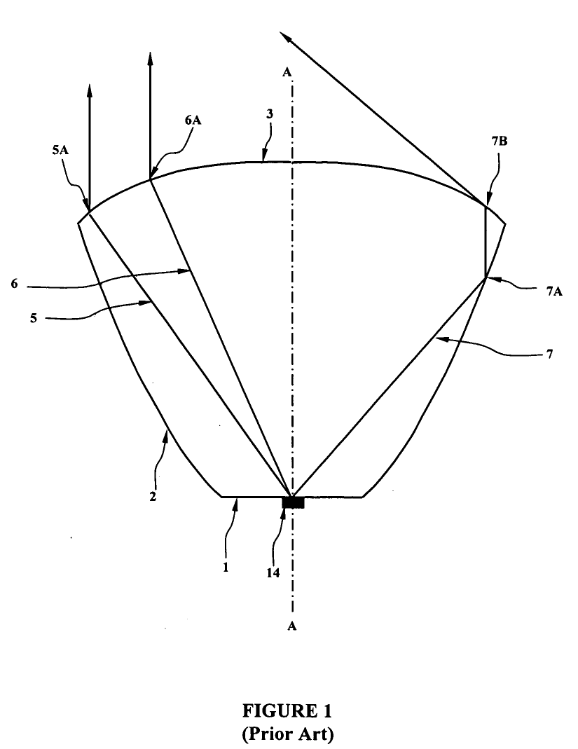

### DETAILED DESCRIPTION

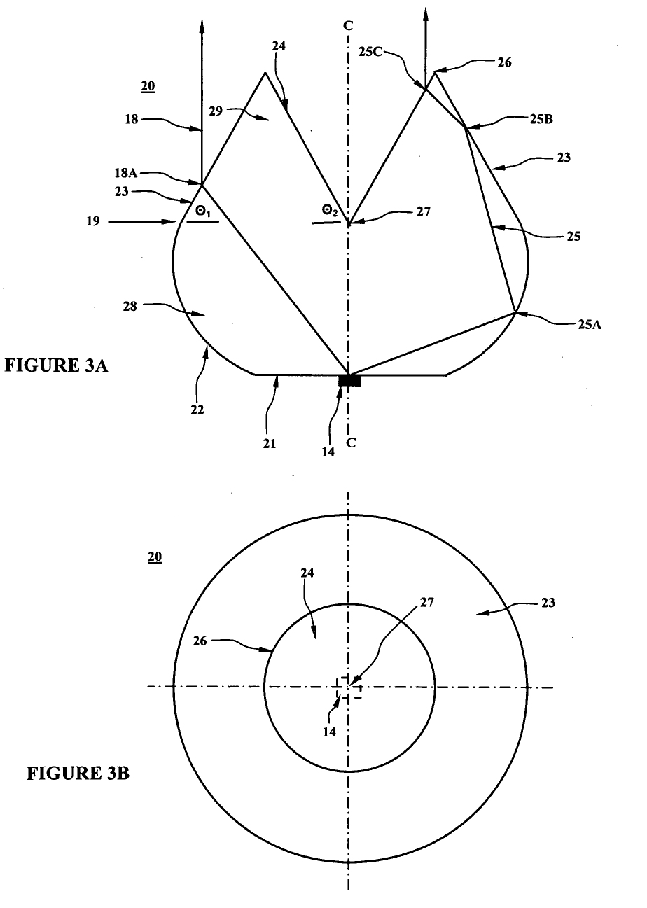

A TIRing condensing optical element 20 for a condensing element system in accordance with embodiments of the present invention is illustrated in FIGS. 3A and 3B. The TIR condensing element 20 includes a first section 28 and a second section 29, although other numbers and types of condensing optical elements each made of other numbers and types of sections and components which are integrally formed or otherwise joined together can be used. The present invention provides a number of advantages including providing a condensing element 20 that may be optically coupled to one or more LED sources to provide low-loss luminance concentration, requires less material to manufacture, has shorter manufacturing (injection molding) cycle times, and has lower overall height than prior condensing element systems.

Referring more specifically to FIGS. 3A and 3B, the condensing element 20 is formed as a monolithic structure, although the condensing element can be formed as two or more structures as described later. The condensing element 20 may be made of glass, although the condensing element could be made of other types and numbers of materials, such as a polymer. Additionally, the condensing element 20 has a refractive index between about 1.4 and 1.7, although the condensing element could include other ranges for the refractive index.

The condensing element 10 has a first section 28 and a second section 29, although the condensing element 20 could have other types and numbers of sections in other configurations. The first and second sections 28 and 29 are integrally formed together, although these sections can be formed or connected together in other manners.

The first section 28 has a one-sided, rotationally symmetric configuration, although the first section 28 may have other types and numbers of sides, shapes, and configurations, such as four-sided, six-sided, eight-sided, triangular, square, and rectangular and could have an asymmetric configuration. The first section 28 has a base 21 and a sidewall 22, although the first section 28 may have other numbers and types of top, bottom and side walls. The base 21 has a plano configuration to facilitate the attachment of the LED 14, although the base 21 may have other configurations, such as convex or concave.

The sidewall 22 is formed to have a curvature that provides substantially total internal reflection of light entering at the base 21 of the first section 28, although the sidewall could have other properties and configurations. In particular, the slope angle of the sidewall 22 is selected so that light from the LED 14 will be substantially totally internal reflected at all locations on the sidewall 22.

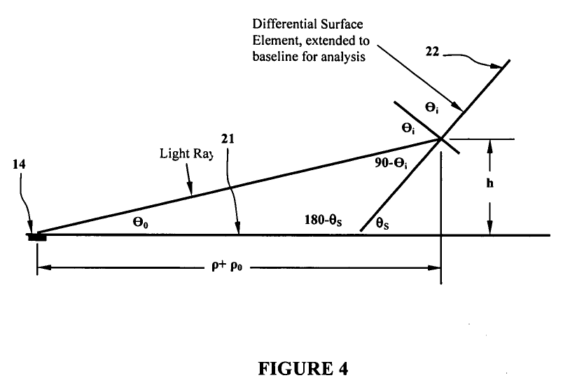

A diagram illustrating an example of the geometrical calculations for determining the curvature of the sidewall 22 to generate TIR in the first section 28 is illustrated in FIG. 4. In these calculations, the variables are:

⊖₀: The light exit angle from the source 14 with respect to the base surface;

⊖ₛ: The instantaneous angle of a differential element of TIRing surface 22 with respect to the base surface 21;

⊖ᵢ: The angle of incidence that the light makes with the differential surface element of surface 22;

h: The vertical distance from the base to the point of incidence on TIRing surface 22;

ρ₀: The lateral distance from the source 14 to the edge of the plano base 21;

ρ: The lateral distance from the edge of the plano base 21 area to the point of incidence on TIRing surface 22.

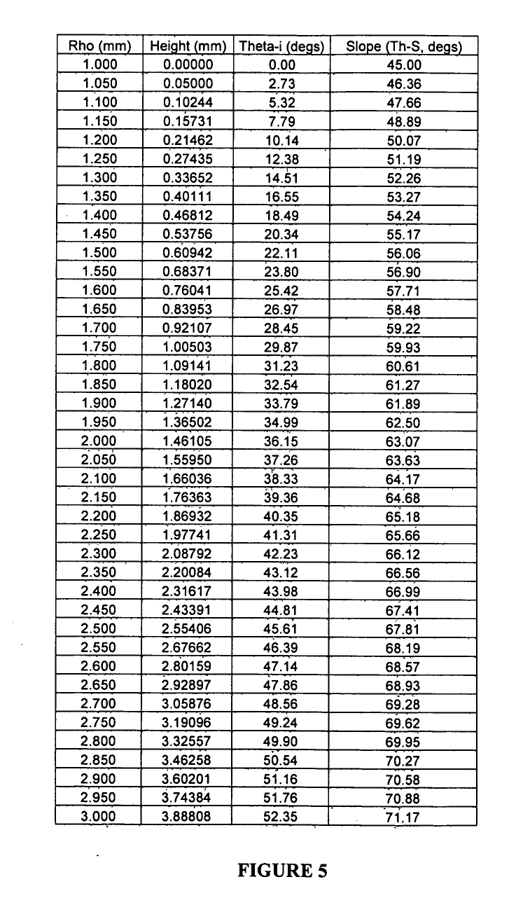

Additionally, in these calculations the critical angle, ⊖_{c}, is defined so that ⊖ᵢ>⊖_{c}+4° for TIR to occur. The +4° is a buffer angle, ⊖_{B}, selected to provide a buffer for robustness, although other angular buffer amounts or no buffer could be used. By inspection, ⊖ₛ=90+⊖₀−(⊖_{c}+4), and from Snell's Law ⊖_{c}=sin¹(1/n), where n is the refractive index of the optical element. Also, h=(ρ+ρ₀)tan ⊖₀, for entry into a spreadsheet for numerical stepwise computation of values, hₙₑₓₜ=hₚᵣₑᵥ+(Δρ)tan ⊖ₛₚᵣₑᵥ. Assuming ρ₀ is 1.0 mm in this example, a spreadsheet with the coordinates of the profiles for the condensing element 20 is illustrated in FIG. 5.

The second section 29 has a rotationally symmetric configuration, although the second section 29 may have other configurations, as described below, and other types and numbers of sides, such as four-sided, six-sided, eight-sided, triangular, square, and rectangular and could have an asymmetric configuration. The transition or boundary from or between the first section 28 to the second section 29 is illustrated by the arrow 19. As shown in FIGS. 3A and 3B, the second section 29 is composed of a circularly symmetric prismatic annulus that is substantially triangular in cross-section, having an apex at ring 26 and a substantially point-like trough at location 27 which resides on optical axis C-C, although the second section 29 may have other numbers and types of walls in other shapes and configurations as described below, such as concave, convex, parabolic, elliptical, or otherwise characterized by a polynomial. The sidewall surfaces 23 and 24 of the second section 29 provides total internal reflection (TIR) and refraction of light so that at least a half-power angle of the light output from the second section 29 is less than the half-power angle of the light entering the first section 28. The angle between the two half-power points of the input or output light is defined as the half-power angle or beam width. The half-power angle of the light entering the first section is greater than or equal to about forty degrees about the optical axis C-C, although other half-power angle distributions could be used and the optical axis could have other orientations which are not substantially perpendicular to the base 21. Additionally the optical emission profile from the second section 29 has a half-power angle less than or equal to ten degrees about the optical axis C-C, although other half-power angle distributions could be used, such as is less than or equal to about twenty degrees, and again the optical axis could have other orientations which are not substantially perpendicular to the base 21.

The annular prismatic cross-sectional shape of the second section 29 can be isosceles, in which case θ₁=θ₂, although other shapes can be used, such as a non-isosceles cross-sectional shape in which case θ₁≠θ₂. The cross-sectional shape of the triangular prismatic second section 29 as shown in FIG. 3A is isosceles, with θ₁=θ₂=70°. The range of angles for θ₁ and θ₂, whether equal or not, can be from about 5° up to about 88°.

To broaden the distribution of condensed light output from the second section 29, one or both of the sidewalls 23 and 24 may be non-linear in cross-section, textured, and/or made from a light diffusing material (also known as a bulk scattering or bulk diffusing material), although other manners for broadening the distribution could be used.

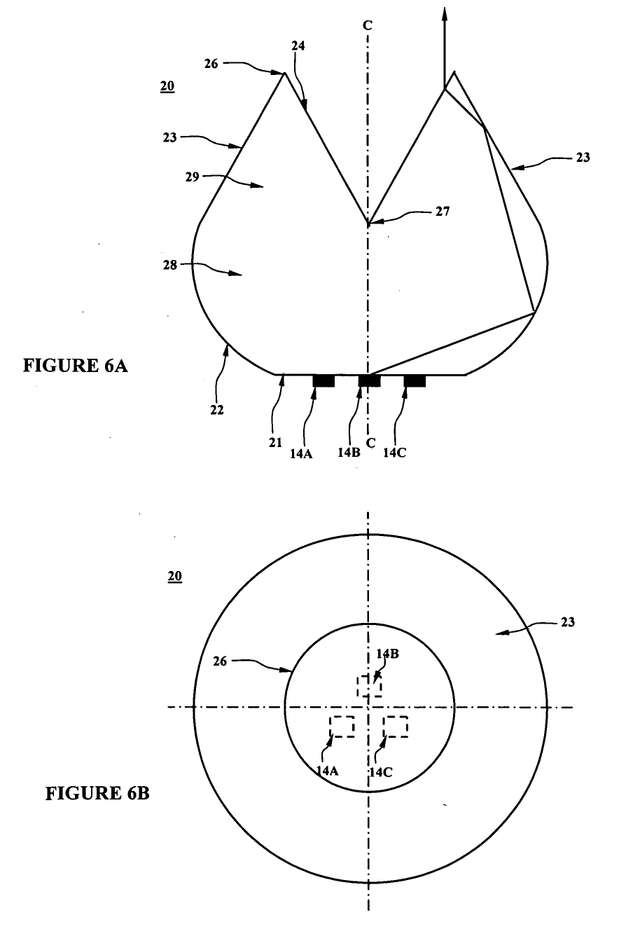

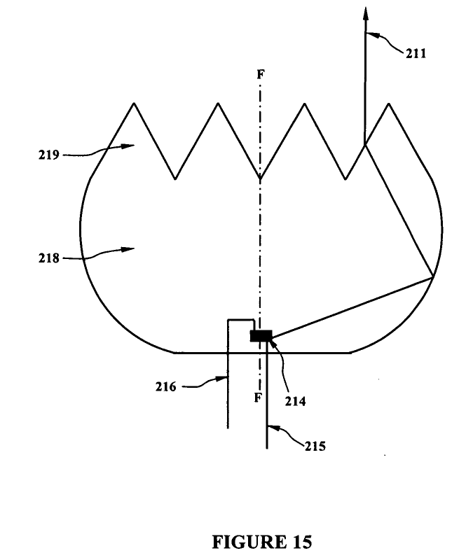

As shown in FIG. 3A, an LED source 14 is attached to the base 21 at the intersection with optical axis C-C, although other numbers and types of light sources attached at other locations and in other manners can be used. For example, the LED source 14 may be partially or fully encapsulated in the first section 28 of condensing element 20 as illustrated in the embodiment shown in FIG. 15. Additionally, by way of example a plurality of LEDs, such as a red LED source 14A, green LED source 14B, and blue LED source 14C, may be provided at the base 21 and arranged about the optical axis C-C as shown in FIGS. 6A and 6B. To ensure TIR in the first section 28, the LEDs can be located near the optical axis C-C and spaced less than 10 mm apart from one another, although other spacing can be used, such as 0.5 mm apart.

When using more than one LED light source, the LEDs are close to one another and near the optical axis C-C of the condensing element 20, although other configurations and locations can be used. In such a case, the buffer angle, ⊖_{B}, may be increased to accommodate the larger effective size of the sources. The LED source 14 is made from inorganic material, although other types of light sources can be used, such as a light source made from organic materials (e.g., OLEDs). LED source 14 is in chip or die format, although the light source can come in other formats, can have leads, and can subsequently be incorporated in the condensing element 20.

The operation of the condensing element 20 will now be described with reference to FIG. 3A. A light ray 25 which exits obliquely from the LED source 14 is transmitted into the first section 28 of condensing element 20 and strikes the sidewall 22. The curvature of the sidewall 22 provides total internal reflection of this light which is eventually directed towards the sidewall 23 of second section 29. The light strikes the sidewall 23 of the second section 29 at location 25B and is internally reflected as the angle of incidence of the light ray 25 at location 25B is greater than the critical angle. The light ray 25 is then reflected towards surface 24, where it is incident at an angle that is less than the critical angle, and the light ray refracts through surface 24. At this point, the condensed light is output from the second section 29. The half-power angle of the light output from the second section 29 is less than the half-power angle of the light entering the first section 28.

Another light ray 18 exiting the LED 14 at a non-oblique angle is transmitted into the first section 28 and strikes the sidewall 23 above the transition or boundary 19 between the first section 28 and second section 29. The sidewall 23 at this point allows the light to refract and transmit through the side of the condensing element 20, although light striking the sidewall 23 at other angles may be internally reflected as illustrated with light ray 25. As can be seen, light rays 18 and 25 exit the second section 29 substantially condensed with respect to the optical axis C-C.

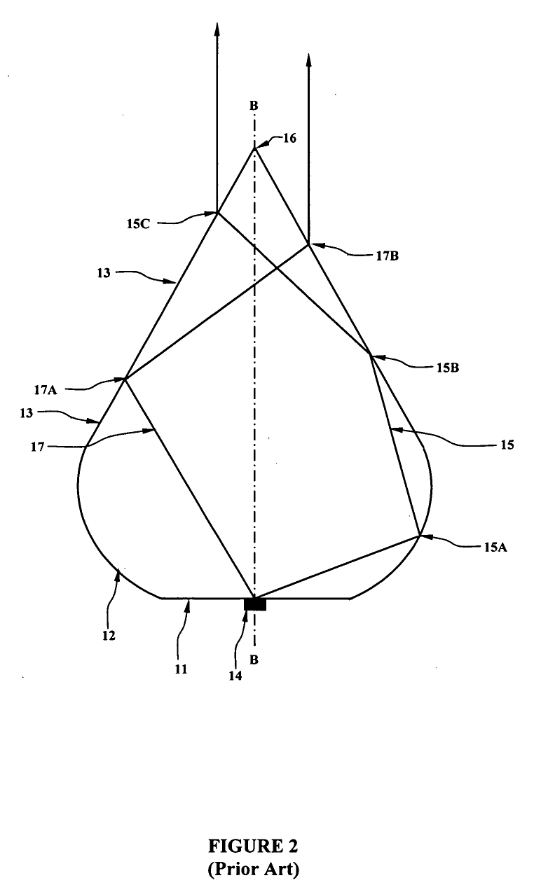

Note the present invention embodied in optical condensing element 20 retains the substantially same optical performance characteristics of the prior art as illustrated in FIG. 2, but has the additional beneficial features of using less material and having a shorter base 21 to peak 26 distance.

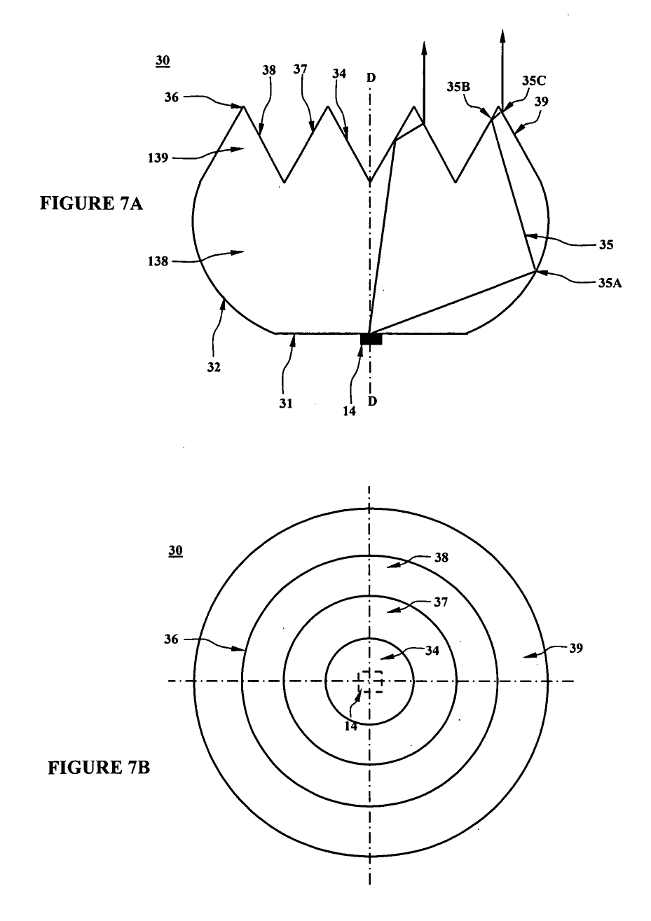

A condensing element 30 for a condensing element system in accordance with other embodiments of the present invention is illustrated in FIGS. 7A and 7B. The height from base to peak is further reduced in this embodiment by splitting the annular triangular prismatic second section described earlier into two or more annular triangular prisms. In particular, the optical condensing element 30 has a base 31 to peak 36 distance (measured along a line parallel to the optical axis D-D, which is also the center line) which is even shorter than the earlier described embodiments. The first section 138 comprising plano input surface 31 and curved TIRing surface 32 is designed, constructed, and operates in same way as the first section 28 of optical condensing element 20 as described earlier and thus will not be repeated here. The second section 139 however has two annular triangular prisms having sidewalls 34, 37, 38, and 39. Even though the number of annular prisms has doubled, and the height of the second section 139 halved (as compared to the embodiment shown in FIGS. 3A and 3B), the manner in which the second section 139 operates is the same as the manner in which second section 29 operates, except as described and illustrated herein. For example rays, such as ray 35, can still TIR from a surface of the second section 139, such as at location 35B on surface 38, where the incidence angle is greater than the critical angle, and can also exit the second section 139 when a ray refracts through a surface, such as at location 35C on surface 39, where the incident angle of the ray is less than the critical angle. Furthermore, the half angle of the envelope of the rays that exit through the second section 139 will be less than the half angle of the envelope of the rays that enter the condensing element 30 through the base 31 after leaving the source 14.

While the condensing element 30 has twice as many annular triangular prisms in the second section 139 as compared to the number of annular triangular prisms of the second section 29 of condensing element 20, it is possible to increase the number of annular triangular prisms further, resulting in an even greater savings in material and condensing element height.

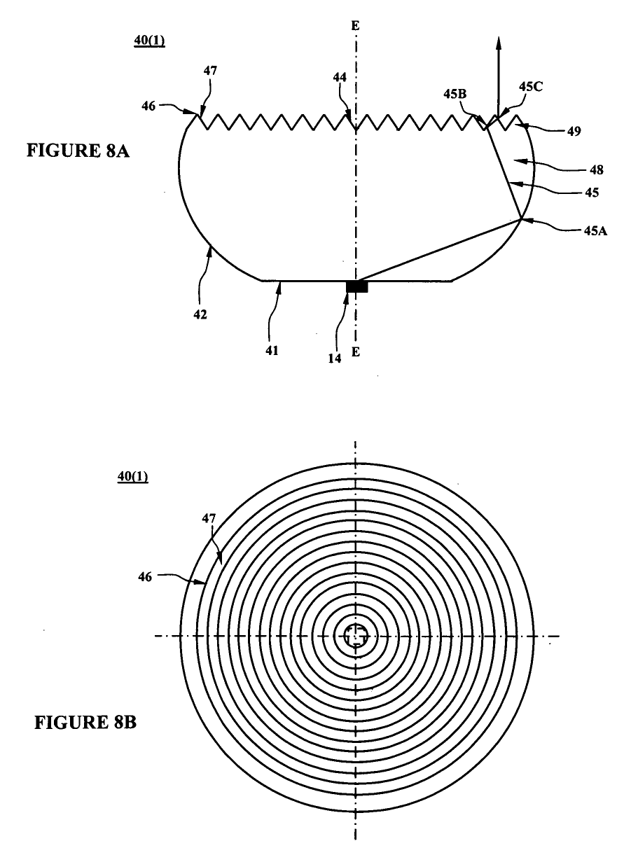

A condensing element 40(1) for a condensing element system in accordance with other embodiments of the present invention is illustrated in FIGS. 8A and 8B. In this embodiment, the condensing element 40(1) as shown in FIGS. 8A and 8B has eight annular triangular prisms in second section 49, although other numbers and types of prism structures could be used. The condensing element 40(1) is designed, constructed, and operates the same as that described in connection with condensing elements 20 and 30 as shown in FIGS. 3A-3B and 7A-7B, respectively, except as described and illustrated herein. As illustrated, the eight annular triangular prisms in second section 49 further reduce the base 41 to peak 46 height resulting in even greater savings in material and condensing element height. An exemplary ray 45 illustrates a path that a ray 45 emitted from an LED source 14 follows as it propagates through and passes out of the condensing element 40 (1).

A variant of the embodiment illustrated and described with reference to FIGS. 8A and 8B is illustrated in FIG. 8C. The condensing element 40(2) for a condensing element system in accordance with other embodiments of the present invention is designed, constructed, and operates the same as the condensing elements 20, 30, and 40(1) described and shown in FIGS. 3A-3B, 7A-7B, and 8A-8B respectively, except as described and illustrated herein.

In the embodiment shown in FIG. 8C, the outer output surface of the second section of the condensing element 40(2) has another configuration. Heretofore, the triangular prismatic structure of the second section have been described as being annular prisms centered about an optical axis, as shown in the top view in FIG. 8B. These annular prisms can be more difficult to tool and mold, and can be especially difficult to align such that it is centered on an optical axis. This is especially problematic in additional embodiments described below. To remedy this, the grooves can be arranged in a grid pattern, such as the two-dimensional array of orthogonal grooves illustrated in FIG. 8C. Being orthogonal, the two sets of triangular grooves comprising the second section of this embodiments as illustrated in the plan view shown in FIG. 8C are oriented about 90 degrees with respect to each other, although other orientations can be used, such as three sets of grooves rotated about 60 degrees apart or four sets of grooves oriented about 45 degrees apart.

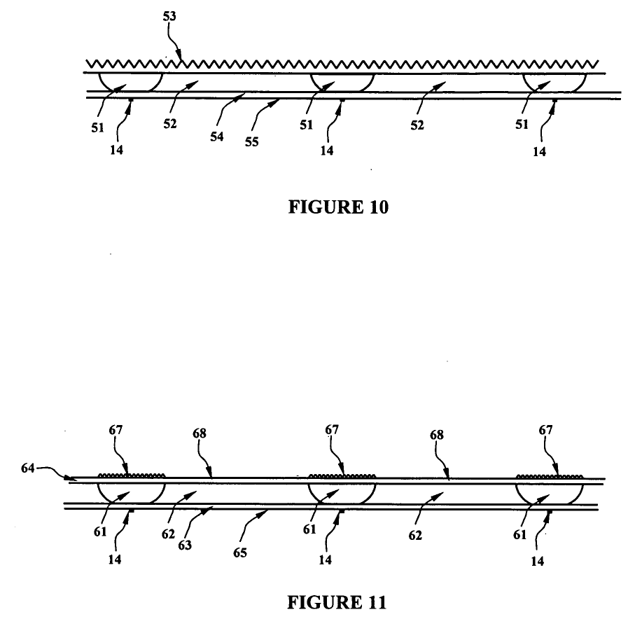

A condensing element system with a plurality of condensing elements in accordance with other embodiments of the present invention is illustrated in FIG. 10. The condensing elements in the condensing element system illustrated and described with reference to FIG. 10 are designed, constructed, and operate the same as the condensing elements illustrated and described with reference to FIGS. 3A-3B, 7A-7B, 8A-8B, an 8C, respectively, except as described and illustrated herein.

There are at least two differences in the embodiment shown in FIG. 10 from what was illustrated and described earlier and each of these difference can be applied together or individually. First, in this embodiment the second section has an output film 53 that is placed across multiple first sections 51 to form multiple condensing elements, although other manners for forming one or more condensing elements can be used. The output film 53 has a microstructure on its output surface or side comprising the peaks and troughs described and illustrated earlier with reference to FIGS. 3A-3B, 7A-7B, 8A-8B, and 8C, although other types of output surfaces could be used, such as a surface relief diffuser, a diffraction grating, a subwavelength anti-reflection microstructure, or a holographic optical element. In this particular embodiment, this microstructure on the output surface of output film 53 is cross-hatched in the manner described and illustrated with reference to FIG. 8C, although the microstructure could be formed in other manners and locations. This microstructure on the output surface of output film 53 is substantially continuous and uninterrupted so that the microstructure on the output film 53 does not need to be aligned with either the first sections 51 or the LED sources 14.

Second, in this particular embodiment an input film 54 of polymer material is placed between the LED sources 14 and the first section 51, although other number and types of layers made of other materials or no film could be used. The first side 55 of the input film 54 is coated with a substantially transparent conductor of electricity, such as indium-tin-oxide ITO by way of example only, so this surface serves as a conductor of electricity that is used supply power to the LED sources 14, although other types and manners of coupling power to the LED sources can be used. The space 52 between the output film 53 and the polymer input film 54 is filled with air, although other types of fluids or materials can be used, such as an inert gas or an adhesive that has a low refractive index, like silicone. The output film 53 is in optical contact with the first sections 51, which is accomplished by first applying a layer of pressure sensitive adhesive (PSA) to the underside of the output film 53, and then pressing the output film onto the first sections 51 so that the PSA bonds the output film 53 onto the first sections 51, although other alignments and manners of optically coupling and securing the output film 53 with the first sections 51 can be used. Advantages of this particular embodiment include the fact that the output film 53 can be produced inexpensively with a roll-to-roll manufacturing process, such as casting, there is no need for alignment of the output film 53 with the first sections 51, and the height of the assembly, measured from the LED sources 14 to the peaks of the output film 53 is small. A tradeoff of this embodiment is that the optical condensing performance of the condensing element system may be compromised.

Another condensing element system with a plurality of condensing elements in accordance with other embodiments of the present invention is illustrated in FIG. 11. The condensing elements in the condensing element system illustrated and described with reference to FIG. 11 are designed, constructed, and operate the same as the condensing elements illustrated and described with reference to FIGS. 3A-3B, 7A-7B, 8A-8B, an 8C, respectively, except as described and illustrated herein.

In this embodiment, the microstructure with the peaks and troughs on the output side or surface of the output film 64 is fabricated so that the microstructure is present substantially only above the first sections 61 as illustrated in FIG. 11, with void areas 68 between the areas of microstructure 67. In FIG. 11, the output film 64 is bonded to the first sections 61 with an adhesive as described above, although the microstructure 67 of the output film 64 will generally need to be aligned so that it is located atop and is optically aligned with the first sections 61. If the microstructure 67 has concentric grooves, such as that described in connection with FIGS. 7A and 7B, then the grooves of each of the microstructure regions 67 will need to be aligned with the LED sources 14. The advantages of this embodiment include the fact that the output film 64 can be produced inexpensively with a roll-to-roll manufacturing, such as casting, the height of the condensing element system or assembly, measured from the LED sources 14 to the peaks of the microstructure 67 of the output film 64 is small, and the optical performance of the assembly will not be compromised. A tradeoff of this embodiment is that the microstructure 67 needs to be aligned with the first sections 61 and/or the LED sources 14 during the assembly process.

The microstructure on the output surface of output films 53 and 64 can be annular rings or can be a cross-hatched array as described in greater detail earlier, although other types of microstructures can be used. If the microstructure is an array, the array can comprise a cross-hatch in which the linear segments are oriented at about 90° angle with each other, although they can be at other angles, such as at about 60° angle. The individual microstructure elements within the array can be lens-shaped, being circular in cross-section or elliptical in cross-section in which the two of the axis are the same or no axis of the ellipse is equal to another axis of the ellipse. The individual microstructure elements within the array can be pyramidal with substantially planar sides. The individual microstructure elements within the array also can be conical, being circular in cross-section or elliptical in cross-section in which the axis of the ellipse are the same or not.

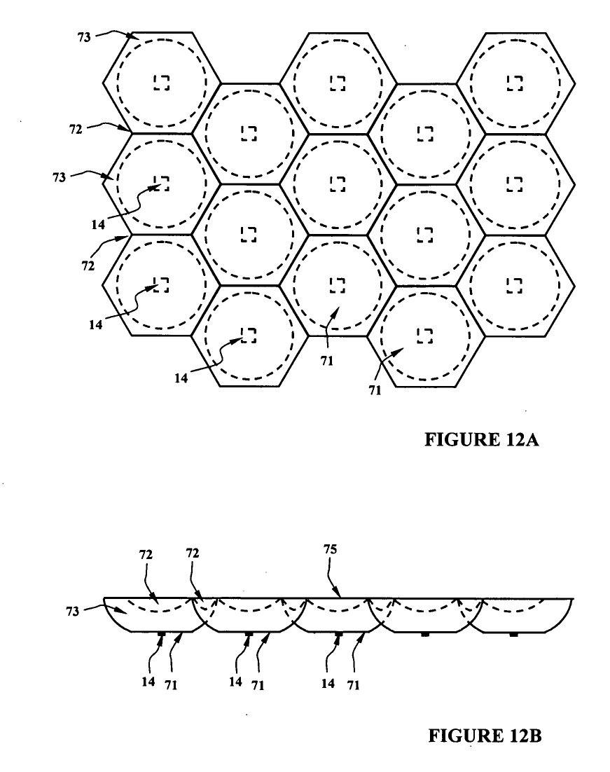

A condensing element system with a monolithic array of overlapping condensing elements in accordance with other embodiments of the present invention is illustrated in FIGS. 12A-12B. The condensing elements in the condensing element system illustrated and described with reference to FIG. 12 are designed, constructed, and operate the same as the condensing elements illustrated and described with reference to FIGS. 3A-3B, 7A-7B, 8A-8B, an 8C, respectively, except as described and illustrated herein.

In the prior embodiments, the first sections 28, 138, 51, and 61 have been described and illustrated as being individual optical components separated from one another. That is, one of the first sections 28, 138, 51, and 61 did not touch or intersect a neighboring first section. This need not be the case in any of the embodiments, and the first sections can be fabricated in a monolithic array in which two or more of the neighboring first sections slightly overlap each other along one or more sides. A top view of such an embodiment of first sections is shown in FIG. 12A, and a side view in FIG. 11B. Note the structure of the second section has been omitted, but any of the second section microstructure 29, 139, 53, or 67 or other types of second structures can be installed over the array of first sections shown in FIGS. 12A and 12B.

In FIG. 12A, the first sections 73 are arranged in a hexagonal array, although other array configurations are possible, including square, rectangular, triangular, or linear. The first sections 73 are in contact with each other along a line or plane 72 bordering on all six sides of the first section 73 as depicted in FIG. 12A. In general the greater the amount of overlap of the first sections 73, the more that the optical qualities of the first section 73 will be compromised. For example, it is desired that oblique light rays from the source LEDs 14 TIR at surface of the first sections 73 as described previously. However, light rays from the sources 14 will not TIR at the intersecting plane 72 regions, and these light rays will instead enter the neighboring first section and then exit the neighboring first section through the top surface 75 at an angle that may not be redirected by the second structure 29, 139, 53, or 67 in a well-condensed manner. The amount of overlap of the array in FIGS. 12A and 12B is such that the overlap does not extend into the plano base input surface 71 to avoid an substantial compromise in condensing performance, although other amounts of overlap could be used. For example, the amount of overlap can be less, so that the corners of the hex-shaped first sections 73 are not touching their neighbors.

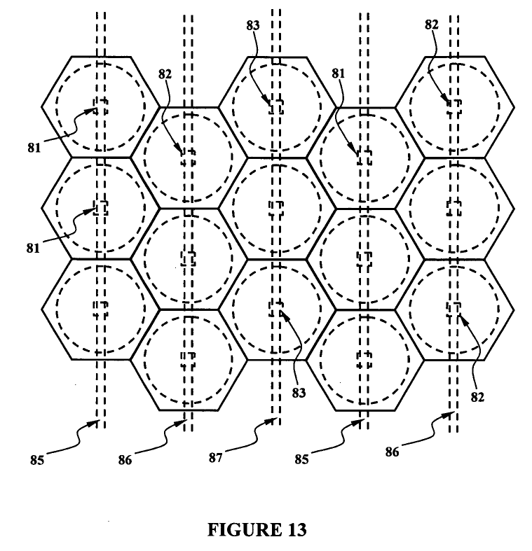

If the condensing elements of the present invention are arranged in an array, whether neighboring elements are overlapping or touching or not, the condensing optical elements and LED die can be arranged along parallel strips (i.e., columns or rows), whose pitch and spacing facilitate the placement of the die substantially centered within each base section of each TIRing condenser. The exemplary array shown in FIG. 13 includes a sequence of blue LED die 81 periodically installed on a conductor 85 and substantially at an optical axis of the condensing element, green LED die 82 periodically installed on a conductor 86 and substantially at an optical axis of the condensing element, and red LED die 83 periodically installed onto conductor 87 and substantially at an optical axis of the condensing element. The LED die arrangement of FIG. 13 is conducive to electrical power routing to the LEDs, heat removal from the die, as well as low-cost (even roll-to-roll) assembly of the LED die circuit assembly. Note that in this example three different LED source colors are provided, although in practice all of the LED sources can be of the substantially same color, two colors, or four or more colors.

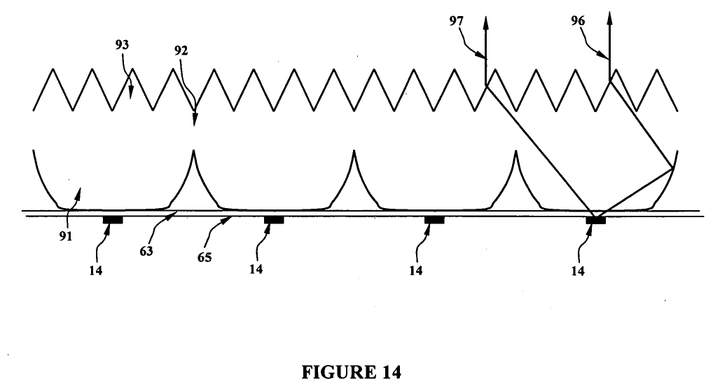

An alternate array configuration is shown in FIG. 14. In this embodiment the first sections 91 are monolithically formed with the second sections 93, and these monolithically formed condensers are joined with neighboring condensers along planes of intersection 92. This construction allows for a low-height condensing element that uses a minimal amount of material and also requires no secondary manufacturing steps in which one or more second sections are installed onto one or more first sections. The microstructure of the second section 93 can be circular, elliptical, or otherwise curved, or the microstructure can be substantially straight and arranged in a cross-hatched array. An input film 63 is also provided, although its inclusion is optional. In FIG. 14 two illustrative rays, 96 and 97 are traced from the source LED 14 to where they exit the second section 93. Ray 96 TIRs from a surface of the first section 91, and after reflection is directed onto microstructure with peaks and troughs on an outer side or surface of a second section 93 of a neighboring condensing element after crossing through a plane of intersection 92. Even though ray 97 originates at one condensing element and exits from the second section 93 of a neighboring condenser, light ray 97 still exits in a condensed manner.

It was mentioned previously in connection with FIG. 6A that the source or sources could be encapsulated in the first section. FIG. 15 illustrates one example of how this can be accomplished as LED source 214, located substantially on optical axis F-F, and leaded with electrical conductors 215 and 216, is encapsulated within the first section 218. Second section 219 can be integrally formed with the first section 218 as previously described or second section 219 can be installed onto first section 218 in a secondary manufacturing step, also as described previously. In either event the first section 218 is typically molded about the LED source 214 in an injection molding process. A typical ray 211 is shown in FIG. 15 as it is emitted from LED source 214 and is subsequently incident upon the sidewall of the first section 218 where it TIRs and is reflected onto the microstructure of the second section 219 where the ray 211 refracts out of the second section 219 in a condensed manner.

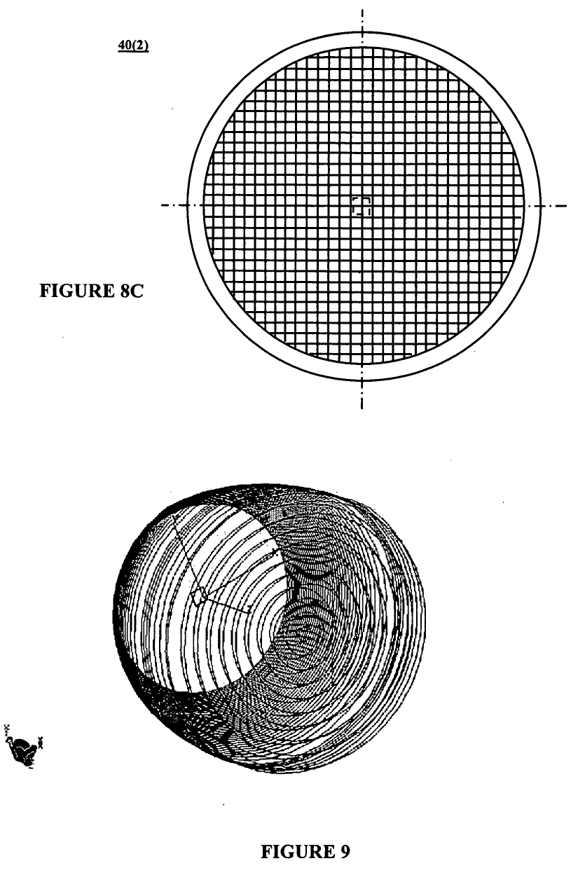

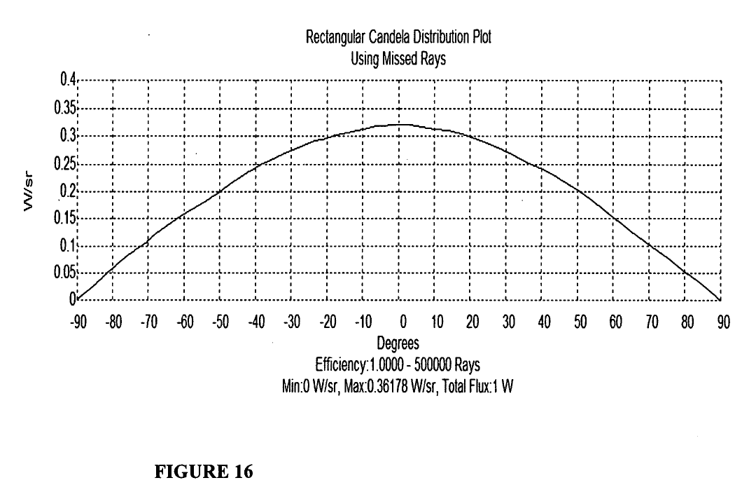

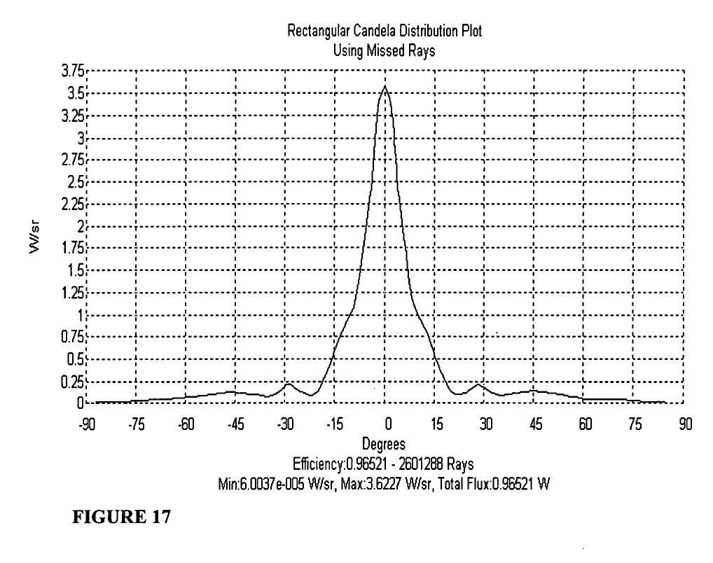

The effectiveness of the present invention is demonstrated by the ray trace shown in FIG. 17 in which the optical emission intensity, as a function of output angle, is plotted. Note that the majority of the light output is within ten degrees of the optical axis, with very little light being emitted at oblique angles. The configuration of the optical condensing element was such that the triangular prisms of the second section were isosceles, having sidewall angles of θ₁=θ₂=70°, and there were ten such triangular prism sections. An isometric view of the condensing element that was raytraced for the plot of FIG. 17 is shown in FIG. 9. For comparison purposes, FIG. 16 presents a similar plot of the output light in which the condensing element was removed. Note the more than tenfold increase in on-axis intensity generated by the condensing element.

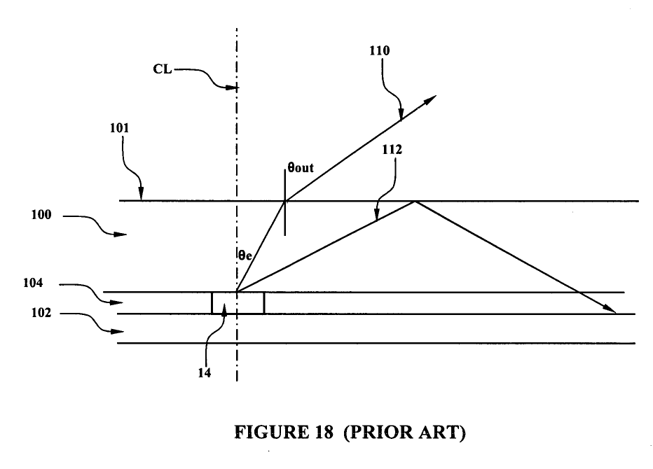

Referring to FIG. 18, a cross-sectional view of a prior art LED die-based light source with two exemplary emitted light paths is illustrated. In this example, the LED die 14 is encapsulated under a substantially transparent layer 100 of polymer material, such as PET, which seals the LED die 14 from environmental contaminants yet allows the light rays emitted from the LED die 14 to propagate through it. An opposing side of the LED die 14 is coupled to an electrical conductor 102 which is used to supply power to the LED die 14 and also to conduct heat away from the LED die 14 generated during operation. The electrical conductor 102 is generally opaque and substantially non-reflective to light rays. An adhesive 104 is placed alongside the LED die 14 to bond the electrical conductor 102, LED die 14, and the transparent layer 100 together which are all in optical contact with one another.

In operation, when power is supplied to the LED die 14 by the electrical conductor 102, light rays are emitted by the LED die 14 into the transparent layer 100. One of these rays is a non-obliquely emitted ray 110 which is emitted into the transparent layer 100 at angle θₑ with respect to the center-line CL. The emitted ray 110 propagates through the transparent layer 100 and exits into the surrounding medium, such as air, at angle θₒᵤₜ in accordance with Snell's Law. Another ray is non-obliquely emitted ray 112 which is emitted into the transparent layer 100 at an oblique angle. When the emitted ray 112 reaches surface 101 of the transparent layer 100, TIR occurs and the ray 112 is reflected back on the substantially non-reflective conductor 102 where it is substantially absorbed. Accordingly, a portion of the rays which are emitted obliquely by the LED die 14 are lost.

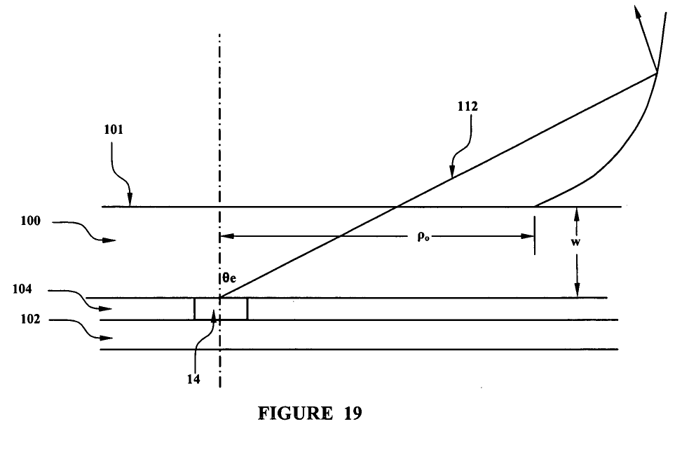

Referring to FIG. 19, a partial, cross-sectional view of a TIRing condensing element in accordance with exemplary embodiments of the present invention coupled to an LED die-based light source along with an exemplary emitted light ray is illustrated. In these embodiments, the LED die 14 also is encapsulated under a substantially transparent layer 100 of polymer material, such as PET, which seals the LED die 14 from environmental contaminants yet allows the light rays emitted from the LED die 14 to propagate through it, although other types and numbers of materials with other properties can be used. An opposing side of the LED die 14 is again coupled to an electrical conductor 102 which is used to supply power to the LED die 14 and also to conduct heat away from the LED die 14 generated during operation, although other manners for coupling power to the LED die 14 and for dissipating heat can be used. The electrical conductor 102 is generally opaque and substantially non-reflective to light, although other types of conductors with other properties can be used. An adhesive 104 is placed alongside the LED die 14 to bond the electrical conductor 102, LED die 14, and the transparent layer 100 together which are all in optical contact with one another, although other manners for optically coupling these elements together can be used. A first section 28, 138, 51, 61, or 91 of a TIRing condensing element, as previously illustrated and described herein, is installed on and is in optical contact with surface 101 of the transparent layer 100.

In operation, when the same ray 112 described earlier with reference to FIG. 18 is emitted by the LED die 14 into the transparent layer 100 at an oblique angle, there is no TIR of the ray 112 at the surface 101 of the transparent layer 100 below the first section 28, 138, 51, 61, or 91 of the condensing element. Instead, the ray 112 simply transmits through the surface 101 and into the first section 28, 138, 51, 61, or 91 of the condensing element. Once the ray 112 is in the first section 28, 138, 51, 61 or 91 of the condensing element, the ray 112 propagates in the manner previously illustrated and described herein. Accordingly, with the addition of the first section 28, 138, 51, 61, or 91 of the condensing element on the surface 101 of the transparent layer 100, more of the light rays emitted by the LED die 14 are collected by the TIRing condensing element thereby improving the overall extraction efficiency of the optical system. In these embodiments, extraction efficiency equals the total light passing through a transparent layer divided by the total light entering the transparent layer.

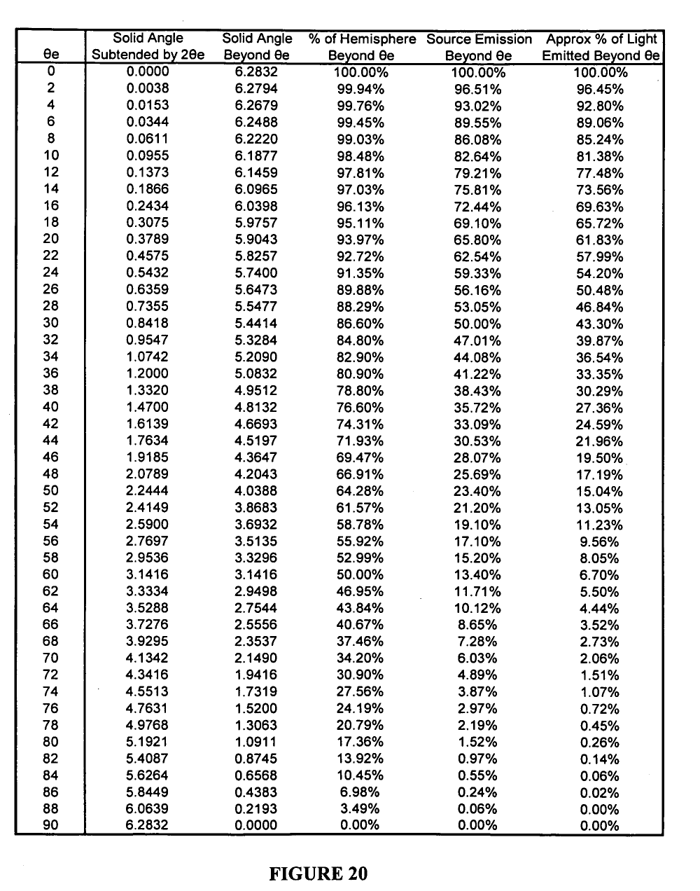

By way of example only, a numerical example to illustrate a typical efficiency improvement with the first section 28, 138, 51, 61, or 91 of the TIRing condensing element on the surface 101 of the transparent layer 100 will now be described. If the refractive index of the transparent layer 100 is 1.556, then its critical angle is 40.0°. To facilitate the calculations, a table of emissions, in percent, as a function of θₑ, in degrees, is presented in FIG. 20. The emissions are assumed to be Lambertian in nature, which follow a cosine-law drop-off with angle θₑ, and the amount of light emitted into angles above 74 ₑ in accordance with the cosine-law is presented in the “Source Emission Beyond θₑ” column. The light collection is also a function of solid-angle, whose calculations are presented in the “Solid Angle . . . ” and “Hemisphere . . . ” columns. The rightmost column, “% of Light Emitted Beyond θₑ” is the multiplication of the cosine-law column and “% of Hemisphere Beyond θₑ” column, and is the column of interest in computing collection efficiencies of the TIRing condensing element 10.

Again, assuming in this particular example, the critical angle is 40.0°, then from the rightmost column of this table 27.36% of the light emitted by the LED die 14 lies outside the 40° critical angle and will be TIR'ed. Accordingly, at this critical angle 72.64% of the light will not be TIR'ed.

Next, if the first section 28, 138, 51, 61, or 91 of the condensing element is now on the surface 101 of the transparent layer 100 and in this particular example the radius of the first section, ρₒ, is 1.0 mm and the width w of the transparent layer 100 is 0.1 mm, the collection angle of the emitted light θₑ is then tan⁻¹(1/0.1)=84.3°. From the rightmost column of this table, at 84°, only 0.06% of the light emitted from the LED die 14 will miss the base 22 and TIR at the surface 101 of the transparent layer 100. In other words, 99.94% of the light emitted by the LED die 14 into transparent layer 100 will be collected by the TIRing condensing element 10, which is a substantial improvement in efficiency.

It is to be appreciated that in any embodiment, optically coupling the LEDs with the first sections can be carried out in a number of ways. For example, the optical condensing element can be adhered to an LED using optically transmissive adhesive material, an LED can include leads and the LED can be encapsulated in the optical condensing element at the base segment with the leads exposed, or the optical condensing element can be mechanically fastened to or held against the LEDs with or without an intervening optically conductive paste.

Accordingly, the condensing element produces a substantially condensed light output. Additionally, the condensing element as described herein is easy and inexpensive to produce with manufacturing procedures, such as injection molding. Further, the resulting condensing element has a compact design that requires less material to manufacture.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A condensing element system comprising:
a first section for each of one or more condensing elements that provides substantially total internal reflection of light entering at a base of the first section; and
a second section for each of the one or more condensing elements, each of the second sections optically coupled to one of the first sections and having an output surface with one or more peaks and one or more troughs, the first and second sections for each of the condensing elements are each configured so a half-power angle of the light output from the second section is less than the half-power angle of the light entering the first section.

2. The system as set forth in claim 1 wherein the one or more peaks and the one or more troughs further comprises a plurality of the peaks and troughs in a concentric arrangement.

3. The system as set forth in claim 2 wherein the plurality of peaks in the concentric arrangement each comprise an annular triangular prism.

4. The system as set forth in claim 1 wherein the one or more troughs comprises two or more sets of triangular shaped grooves which are oriented about ninety degrees or less with respect to each other in the outer surface.

5. The system as set forth in claim 1 wherein the first section has at least one sidewall with a curvature to provide the substantially total internal reflection of light entering at the base of the first section.

6. The system as set forth in claim 5 wherein the second section has at least one sidewall which is substantially linear in cross-section and provides internal reflection and refraction of the light from the first section.

7. The system as set forth in claim 6 wherein the half-power angle of the light output from the second section is less than or equal to about twenty degrees about an optical axis of each of the one or more condensing elements which extends through the first section and the second section.

8. The system as set forth in claim 7 wherein the half-power angle of the light entering the first section is greater than or equal to about forty degrees about the optical axis.

9. The system as set forth in claim 1 further comprising at least one light source positioned to transmit light at least one of in and into the first section of the condensing element.

10. The system as set forth in claim 9 wherein the at least one light source comprises at least one light emitting diode.

11. The system as set forth in claim 9 wherein the at least one light source comprises multiple light sources positioned adjacent an optical axis of each of the one or more condensing elements which extends through the first section and the second section to transmit light at least one of in and into the first section of the condensing element.

12. The system as set forth in claim 11 wherein the multiple light sources comprise a red light source, a green light source, and a blue light source.

13. The system as set forth in claim 1 further comprising at least one input film optically coupled to an opposing surface of the first sections from the second sections.

14. The system as set forth in claim 1 wherein the one or more condensing elements comprise a plurality of the first sections which are each spaced apart and a plurality of the second sections comprising a film with a continuous pattern of the one or more peaks and one or more troughs.

15. The system as set forth in claim 1 wherein the one or more condensing elements comprise a plurality of the first sections which are each spaced apart and a plurality of the second sections comprising a film with a spaced apart pattern of the one or more peaks and one or more troughs at least partially, optically aligned the first sections.

16. The system as set forth in claim 15 wherein the second sections are each substantially optically aligned with the first sections.

17. The system as set forth in claim 1 wherein the one or more condensing elements comprise a plurality of the condensing elements having a plurality of the first sections and a corresponding plurality of the second sections, the plurality of condensing elements are arranged in an array with at least two or more of the condensing elements touching.

18. The system as set forth in claim 17 wherein each of the first sections has a base which is substantially plano and wherein an overlap between each of the first sections in the array does not substantially extend into the plano base for any of the first sections.

19. The system as set forth in claim 18 further comprising at least one conductive strip with a plurality of light sources positioned to emit light at least one of in and into the first sections in the array.

20. The system as set forth in claim 1 wherein the first section and the second section of the condensing element are integrally formed together.

21. A method for making a condensing element system comprising:
forming a first section for each of one or more condensing elements that provides substantially total internal reflection of light entering at a base of the first section; and
forming a second section for each of one or more condensing elements optically coupled to one of the first sections and having an output surface with one or more peaks and one or more troughs, the first and second sections are configured so a half-power angle of the light output from the second section is less than the half-power angle of the light entering the first section.

22. The method as set forth in claim 21 wherein the forming a second section further comprises forming a plurality of the one or more peaks and one or more troughs in a concentric arrangement.

23. The method as set forth in claim 22 wherein the plurality of peaks in the concentric arrangement each comprises an annular triangular prism.

24. The method as set forth in claim 21 wherein the forming a second section further comprises forming two or more sets of triangular shaped grooves which are oriented about ninety degrees or less with respect to each other in the outer surface to form a plurality of the one or more peaks and troughs.

25. The method as set forth in claim 21 wherein the forming the first section further comprises forming at least one sidewall with a curvature to provide the substantially total internal reflection of light entering at the base of the first section.

26. The method as set forth in claim 25 wherein the forming the second section further comprises forming at least one sidewall which is substantially linear in cross-section and provides internal reflection and refraction of the light from the first section.

27. The method as set forth in claim 26 wherein the half-power angle of the light output from the second section is less than or equal to about twenty degrees about an optical axis of each of the one or more condensing elements which extends through the first section and the second section.

28. The method as set forth in claim 27 wherein the half-power angle of the light entering the first section is greater than or equal to about forty degrees about the optical axis.

29. The method as set forth in claim 21 further comprising positioning at least one light source to transmit light at least one of in and into the first section of the condensing element.

30. The method as set forth in claim 29 wherein the at least one light source comprises at least one light emitting diode.

31. The method as set forth in claim 29 wherein the positioning at least one light source further comprises positioning multiple light sources adjacent an optical axis of each of the one or more condensing elements which extends through the first section and the second section to transmit light at least one of in and into the first section of the condensing element.

32. The method as set forth in claim 31 wherein the multiple light sources comprise a red light source, a green light source, and a blue light source.

33. The method as set forth in claim 21 further comprising optically coupling at least one input film to an opposing surface of the first sections from the second sections.

34. The method as set forth in claim 21 wherein the one or more condensing elements comprise a plurality of the first sections which are each spaced apart and a plurality of the second sections comprising a film with a continuous pattern of the one or more peaks and one or more troughs.

35. The method as set forth in claim 21 wherein the one or more condensing elements comprise a plurality of the first sections which are each spaced apart and a plurality of the second sections comprising a film with a spaced apart pattern of the one or more peaks and one or more troughs at least partially, optically aligned the first sections.

36. The method as set forth in claim 35 wherein the second sections are each substantially optically aligned with the first sections.

37. The method as set forth in claim 21 wherein the one or more condensing elements further comprises a plurality of the condensing elements having a plurality of the first sections and a corresponding plurality of the second sections, the plurality of condensing elements are arranged in an array with at least two or more of the condensing elements touching.

38. The method as set forth in claim 37 wherein each of the first sections has a base which is substantially plano and wherein an overlap between each of the first sections in the array does not substantially extend into the plano base for any of the first sections.

39. The method as set forth in claim 38 further comprising positioning at least one conductive strip with a plurality of light sources to emit light at least one of in and into the first sections in the array.

40. The method as set forth in claim 21 wherein the forming the first section and the forming the second section further comprises forming the first section and second section of the one or more condensing elements integrally together.
